(19) United States
(12) Patent Application Publication
(10) Pub. No.: US 2013/0260580 A1
(43) Pub. Date: Oct. 3, 2013

(54) SINGLE-POLE ELECTRICAL CONNECTOR HAVING BUTT CONTACTS

(71) Applicant: Mounim Houir Alami, Paris (FR)

(72) Inventor: Mounim Houir Alami, Paris (FR)

(73) Assignee: SOCIETE D'EXPLOITATION DES PROCEDES MARECHAL, Saint-Maurice Cedex (FR)

(21) Appl. No.: 13/825,526

(22) PCT Filed: Sep. 20, 2011
(86) PCT No.: PCT/FR2011/000509

§ 371 Date: Jun. 20, 2013

(30) Foreign Application Priority Data
Sep. 22, 2010 (FR) 1003765

(51) Int. Cl. H01R 13/52

(52) U.S. Cl. CPC H01R 13/5213
USPC 439/135

(57) ABSTRACT

The invention relates to single-pole electrical connector having butt contacts, consisting of an active base (1) and a plug (2) provided with a contact pin (3) which is to penetrate into the base (1) in order to engage with a resilient contact (4) provided in the latter, at least the penetrating portion of said contact pin (3) of said plug (2) having a generally substantially rectangular cross-section, and said base (1) being further provided, at the end thereof, with a protective disk (5) in which a pass-through opening (6) is provided, said pass-through opening having a rectangular cross-section that corresponds to the cross-section of the pin (3) of the plug (2), particularly characterized in that the small sides of the rectangular pin (3) comprise lugs (7) for engaging with rails of the base (1), while the rectangular pass-through opening of the protective disk of the base comprises notches on the small sides thereof through which said lugs (7) are to pass.

The invention relates to a single-pole electrical connector having butt contacts, preferably for high power currents.

To meet the standards presently in force for ensuring the safety of persons and property, electrical appliances must offer a minimum degree of protection to prevent access to live parts when the operating voltage is greater than 50 volts.

To verify that such protection is provided, use is made of a jointed test finger defined in accordance with a standard.

The tests consist in making sure that it is not possible to produce a contact between the standard test finger and the live parts of the appliance being tested while trying to introduce the test finger in every possible position.

In the field of connectors, protection can be obtained by protecting each live contact with a shutter or by placing it in a retracted position in an insulating enclosure so that it is out of reach of the test finger.

However, in the case of high currents, i.e. with a high amperage (greater than 200 Amperes for example) and with voltages of more than 50 volts, the conductors and the contact elements in the known appliances have substantial cross-sections for passage of the current, and compliance with the standard is difficult because the diameter of the contact elements approaches or is greater than the maximum diameter of the test finger.

This is why a particular solution with a cylindrical pin and socket has been envisaged for such currents and more particularly for single-pole connectors until now.

In this solution, in contrast to industrial power outlets, the live contacts are the pins the ends of which are protected by an insulator, as for example in the embodiment described in U.S. Pat. No. 3,662,296.

Thus, the electrical connection between the live pin and the mating socket can be made through a portion of the pin which is not accessible with the test finger.

It is clear that such a solution is unsuitable for butt contacts with which by definition the electrical connection is made between the end of a contact pin and a resilient contact which moves under pressure so that the end of the pin obviously cannot be insulated.

This is why it had appeared to be inconceivable to use butt contacts for high currents employing conductors with substantial cross-sections due to the fact that the pins would be larger than the test finger.

However, patent EP 1 518 299 in the name of the same applicant describes a connector having a butt contact specially for high currents.

With the aim in particular of ensuring compliance with the standard for the test finger, the invention proposes a different solution.

The single-pole electrical connector having butt contacts according to the invention is formed of an active base and of a plug provided with a contact pin which is designed to penetrate into the base in order to cooperate with a resilient contact arranged in the latter as described in patent EP 1 518 299 mentioned previously, or again in patent FR 1 398 945 also in the name of the applicant, with at least the penetrating portion of the contact pin of the plug having a generally substantially rectangular cross-section and the base additionally being provided at its end with a protective disk in which is formed a through-opening of rectangular cross-section corresponding to the cross-section of the pin of the plug, but which is however remarkable in that the small sides of the rectangular pin comprise lugs which are designed to cooperate with rails of the base to provide a lock of bayonet type for the plug in the base, whereas the rectangular through-opening of the protective disk of the base comprises on its small sides notches for passage of said lugs.

This makes it possible in particular to determine a size for the small sides for the through-opening which prevents any penetration of the test finger.

Single-pole connectors are generally used in sets, each connector being designed to form a separate and specific connection element, such as for example a set of five connectors one of which is designed to form a ground connection, another the neutral, and the three other phase connections.

In this case, it is obviously of paramount importance that each plug is connected to its corresponding base.

Simple coloured reminders can be insufficient however the invention allows genuine keying which prevents any incorrect connection.

To this end, according to one embodiment, the pin of the plug is surrounded by a cylindrical sleeve in which the protective disk of the base is introduced, said sleeve having on its internal wall a rib or respectively an axial cut designed to cooperate with a cut or respectively a corresponding axial rib arranged on the periphery of the protective disk of the base, the angular offsets being equal between, firstly, a median longitudinal plane of the pin of the plug parallel to its large sides with a plane diametral to the sleeve of said plug passing through the rib or the cut of said sleeve and, secondly, a median longitudinal plane of the through-opening of the protective disk of the base parallel to the large sides of said through-opening with a diametral plane of the protective disk passing through the cut or respectively the rib of the latter.

For example, the angular offsets mentioned above can be substantially equal to 30° or a multiple of 30°. The offsets for five separate connectors can then be 30°, 60°, 90°, 120° and 150°.

It is thus impossible to couple any plug with a base other than the one for which it is intended.

According to one embodiment, the sleeve of the plug is provided with an elastically retractable piston designed to come into contact with a collar of the base and engage, after rotation of the plug, in a notch in said collar in the connecting position of the contacts of the base and the plug in order to prevent any rotation and thus any untimely disconnection.

The invention will be clearly understood on reading the description which follows and refers to the attached drawings in which:

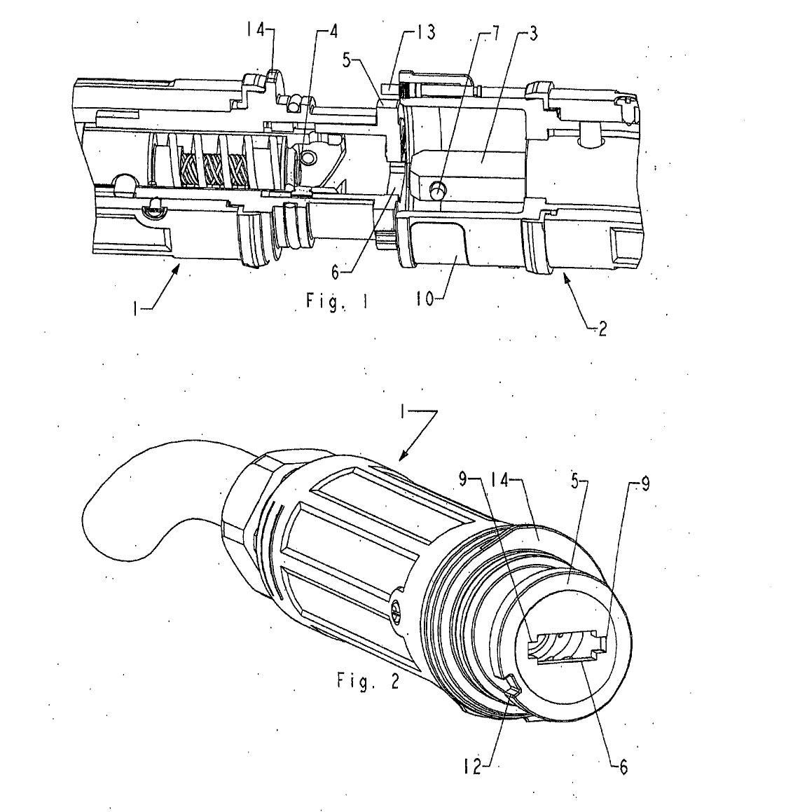

FIG. 1 is a cutaway view of a connector according to the invention the base and plug of which are in position ready to be coupled;

FIG. 2 is a perspective view of the connecting base;

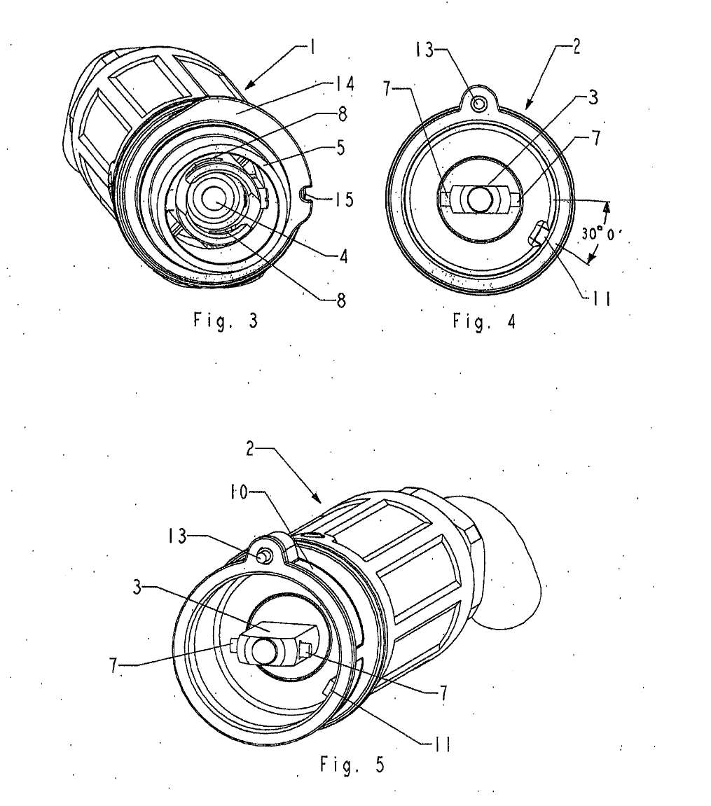

FIG. 3 is also a perspective view of the connecting base but without its protective disk;

FIG. 4 shows the plug in a front view;

FIG. 5 shows the plug in FIG. 4 in perspective;

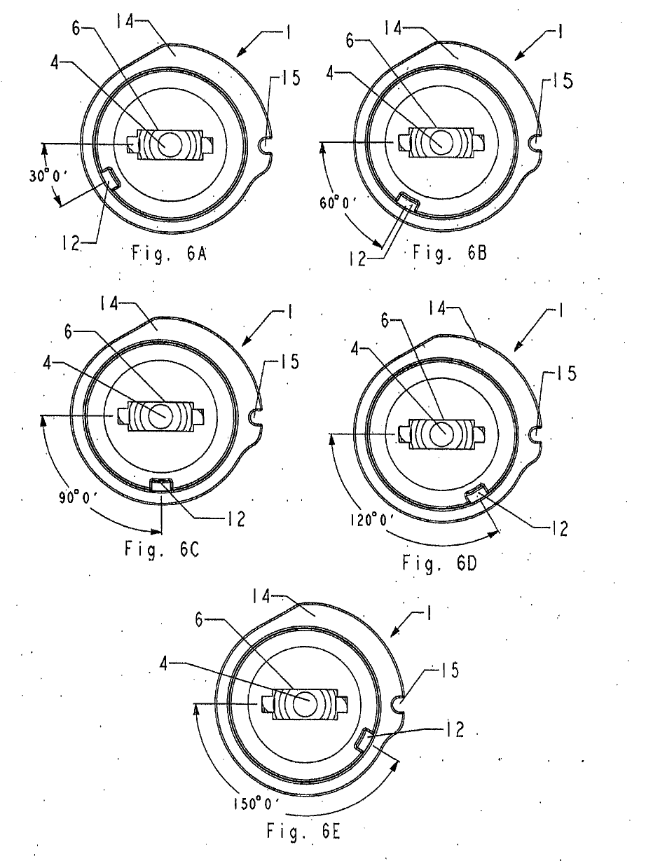

FIGS. 6A to 6E show front views of five separate connecting bases each designed to be coupled with a corresponding plug not shown.

A connector according to the invention comprises a base 1 which is active, i.e. live, and a plug 2 provided with a contact pin 3.

FIG. 1 is a cutaway view of the base 1 and the plug 2 of the connector in position ready to be coupled.

The pin 3 of the plug 2 is designed to cooperate, after coupling, with a butt contact 4 which moves resiliently under pressure and is arranged in the base 1.

The base is also provided at its end with a protective disk 5.

The pin 3 of the plug has a substantially rectangular cross-section, as can be seen in particular in FIGS. 1, 4 and 5, whereas the protective disk of the base is provided with a through-opening 6 of rectangular cross-section which corresponds with the previously mentioned cross-section of the pin of the plug.

Moreover, in the embodiment shown, the pin 3 of the plug is provided with two lateral lugs 7 (FIGS. 1, 4 and 5) designed to cooperate with rails 8 (FIG. 3) of the base to provide a lock of bayonet type after coupling.

The through-opening 6 of the protective disk of the base comprises notches 9 (FIG. 2) on its small sides for passage of the lugs 7 of the pin 3 of the plug.

The pin 3 of the plug is additionally surrounded by a cylindrical sleeve 10 into which the protective disk 5 of the base is introduced, as shown more particularly by FIG. 1.

It can be seen in FIGS. 4 and 5 that the cylindrical sleeve 10 is additionally provided with an internal longitudinal rib 11.

Correspondingly, the protective disk 5 of the base is provided on its periphery with an axial cut 12, as shown clearly by FIGS. 2 and 6A to 6E.

Although in the embodiment shown a rib is provided on the plug and a cut in the base, the reverse could of course apply.

As shown clearly by FIGS. 4 and 5 for the plug and FIG. 2 for the base, the angular offsets are equal between, firstly, a median longitudinal plane of the pin 3 of the plug parallel to its large sides with a plane diametral to the sleeve 10 of said plug passing through the rib 11 of said sleeve and, secondly, a median longitudinal plane of the through-opening 6 of the protective disk of the base parallel to the large sides of said through-opening with a diametral plane of the protective disk passing through the cut 12 of the latter.

In this way, genuine keying is created which makes it possible to prevent connection of a plug and a base which are mutually incompatible.

In the example shown in FIGS. 1 to 6A, this offset is 30° (see more particularly FIGS. 4 and 6A for the plug and the base respectively).

To provide a set of connectors, for example a set of five connectors one of which is designed to form a ground connection (FIGS. 1 to 6A), another the neutral (FIG. 6E), and the three other phase connections (FIGS. 6B to 6D), it is sufficient to provide different angular offsets for each connector, as shown clearly by said FIGS. 6A to 6E.

FIG. 6A shows a front view of a base corresponding to the base in FIGS. 1 and 2 with an angular offset for the cut 12 as defined above of 30°, while FIGS. 6B to 6E show bases with angular offsets for the cut 12 of respectively 60°, 90°, 120° and 150°.

To correspond with the five bases shown diagrammatically in FIGS. 6A to 6E, naturally mating plugs are provided the ribs 11 of which have corresponding angular offsets.

To avoid untimely disconnections, it can additionally be seen in the drawings that in this example the cylindrical sleeve 10 of the plug is provided with an elastically retractable piston 13 (see in particular FIGS. 1, 4 and 5).

This piston 13 is designed to come into contact with a collar 14 arranged around the base (FIGS. 1, 2, 3 and 6A to 6E) in the course of coupling, retract and, after rotation of the plug and coupling, engage in a notch 15 formed in said collar (FIGS. 3 and 6A to 6E).

In this way, the plug and the base are locked in rotation and can only be unlocked by retraction of the piston 13, optionally by means of a special tool.

Other particular features are naturally provided, such as for example a seal arranged on the base or again a cover designed to cover the end of the base and so block its through-opening 6 when the plug and the base are separated.

1. Single-pole electrical connector having butt contacts, formed of an active base and a plug provided with a contact pin which is designed to penetrate into the base in order to cooperate with a resilient contact arranged in the latter, with at least the penetrating portion of said contact pin of said plug having a generally substantially rectangular cross-section and said base being additionally provided at its end with a protective disk in which is formed a through-opening of rectangular cross-section corresponding to the cross-section of the pin of the plug, wherein the small sides of the rectangular pin comprise lugs designed to cooperate with rails of the base to provide a lock of bayonet type for the plug in the base, whereas the rectangular through-opening of the protective disk of the base comprises on its small sides notches for passage of said lugs.

2. The connector according to claim 1, wherein the pin of the plug is surrounded by a cylindrical sleeve into which the protective disk of the base is introduced, said sleeve comprising on its internal wall a rib or respectively an axial cut, designed to cooperate with a cut or respectively a corresponding axial rib arranged on the periphery of the protective disk of the base, the angular offsets being equal between, firstly, a median longitudinal plane of the pin of the plug parallel to its large sides with a plane diametral to the sleeve of said plug passing through the rib or the cut of said sleeve and, secondly, a median longitudinal plane of the through-opening of the protective disk of the base parallel to the large sides of said through-opening with a diametral plane of the protective disk passing through the cut or respectively the rib of the latter.

3. The connector according to claim 2, wherein the angular offsets between, firstly, a median longitudinal plane of the pin of the plug parallel to its large sides with a plane diametral to the sleeve of said plug passing through the rib or the cut of said sleeve and, secondly, a median longitudinal plane of the through-opening of the protective disk of the base parallel to the large sides of said through-opening with a diametral plane of the protective disk passing through the cut or respectively the rib of the latter are equal and substantially equal to 30° or a multiple of 30°.

4. The connector according to claim 1, wherein the sleeve of the plug is provided with an elastically retractable piston which is designed to come into contact with a collar of the base and engage in a notch of said collar in the connecting position of the contacts of the base and of the plug in order to prevent any rotation and hence any untimely disconnection.

5. The connector according to claim 2, wherein the sleeve of the plug is provided with an elastically retractable piston which is designed to come into contact with a collar of the base and engage in a notch of said collar in the connecting position of the contacts of the base and of the plug in order to prevent any rotation and hence any untimely disconnection.

6. The connector according to claim 3, wherein the sleeve of the plug is provided with an elastically retractable piston which is designed to come into contact with a collar of the base and engage in a notch of said collar in the connecting position of the contacts of the base and of the plug in order to prevent any rotation and hence any untimely disconnection.
